(19) United States
(12) Patent Application Publication
(10) Pub. No.: US 2007/0005318 A1
(43) Pub. Date: Jan. 4, 2007

(54) System and method for chemical process simulations

(76) Inventors: Richard A. Dimenna, Evans, GA (US); James M. Becnel, Martinez, GA (US); Michael V. Gregory, Aiken, SC (US); Glenn A. Taylor, Aiken, SC (US)

Correspondence Address: MCNAIR LAW FIRM, P.A., P.O. BOX 10827, GREENVILLE, SC, 29603-0827, US

(21) Appl. No.: 11/157,301

(22) Filed: Jun. 20, 2005

(51) Int. Cl. G06G 7/58; G06G 7/48

(52) U.S. Cl. 703/12

(57) ABSTRACT

The invention is a system and method for simulating a chemical process across multiple computers in communication with each other. The system and method operate by receiving input representing parameters for the chemical process to be simulated. The chemical process is partitioned into a plurality of sections based on said parameters. Each partitioned section is assigned to a computer having simulation programs. The operation of each simulation program is scheduled on each computer so that the chemical process is accurately simulated. The operation of at least one simulation program is initiated. Process data representing materials in the chemical process is transmitted from one remote computer to a second remote computer. Information representing the status of the chemical process simulation is output.

This invention was made with Government support under Contract No. DE-AC09-96SR18500 awarded by the United States Department of Energy. The Government has certain rights in the invention.

### FIELD OF THE INVENTION

This invention relates to a system and method for chemical process simulations. Specifically, this invention is directed to a system and method for scheduling and conducting chemical process simulations across multiple networked computers.

### BACKGROUND OF THE INVENTION

It is well known in the art that it is advantageous to have computer simulations of chemical process facilities. Several attempts have been made at simulating chemical process facilities on computers. Most of those attempts focus on chemical process simulations that run on a single CPU. This single CPU performs the simulation of a chemical process. The use of a single CPU severely limits the user's ability to simulate large chemical processes.

Other attempts to simulate chemical processes have been made using multiple CPUs within a single computer to process chemical simulations. While the processors are faster, only a single memory is used also limiting the scope of simulations that can be run. Still others have attempted to use multiple computers to execute independent simulations over networked computers. This allows independent simulations to be run quickly but does not allow large processes to be simulated. However, no simulation software has been developed that allows a single chemical process simulation to be parallelized across multiple network computers by distributing the chemical processes instead of the mathematical operations.

### SUMMARY OF THE INVENTION

The present invention is a system for simulating a chemical process across a plurality of computers. The system includes a local computer readable medium; a local processor in communication with the computer readable medium; a remote computer readable medium in communication with the local computer readable medium; a remote processor in communication with the remote computer readable medium; and a simulation program in communication with the local computer readable medium for simulating a chemical process. The invention further includes a set of local interface computer readable instructions in communication with the local computer readable medium including scheduling instructions when processed by the processor for partitioning a chemical process into multiple sections, beginning and ending operation of said simulation program, and transmitting information to said remote computer readable medium and said simulation program. The instructions further include input instructions when processed by said processor for receiving input from a user representing parameters for the chemical process simulation. The system includes a set of remote interface computer readable instructions in communication with the remote computer readable medium including receiving instructions when processed by said processor for receiving information from said simulation program representing the status of the chemical process simulation. The instructions further include transmission instructions for when processed by said processor transmitting information to said local and remote computer readable media representing status of said chemical process simulation.

The local interface instructions may further include partitioning instructions for analyzing the chemical process to be simulated to determine the run times of portions of the chemical process in order to partition the simulation based on said parameters input by the user and said run times of said portions of the chemical process. The partitioning instructions allow the user to partition the chemical process into sections of similar run times.

The system may further comprise a plurality of remote computer readable media in communication with said local computer readable medium. The set of remote interface instructions may include data transmission instructions for transmitting process data from one remote computer readable medium to another remote computer readable medium receiving process data. The system process data represents material that is transferred during the chemical process.

The scheduling instructions may include inventory management instructions for transmitting said process data to another remote computer readable medium only if said remote computer readable medium can receive the process data.

The invention is further directed to a method for simulating a chemical process across multiple computers in communication with each other. The method comprises the steps of receiving input representing parameters for the chemical process to be simulated. Further, the chemical process can be analyzed to determine run times of various sections of the chemical process such that the chemical process is partitioned into a plurality of sections based on said parameters and run times. Each partitioned section is assigned to a computer having simulation programs. The operation of each simulation program is scheduled on each computer so that the chemical process is accurately simulated. The operation of at least one simulation program is initiated. Process data representing materials in the chemical process is transmitted from one remote computer to a second remote computer. Information representing the status of the chemical process simulation is output.

### DESCRIPTION OF THE DRAWINGS

FIG. 1 is a block diagram illustrating an embodiment of the invention as used to simulate a chemical process;

FIG. 2 is a schematic illustrating an example chemical process to be simulated;

FIG. 3 is a schematic illustrating the example process to be simulated having been partitioned into four processors to be simulated;

FIG. 4 is a flowchart illustrating the operation of the invention.

### DESCRIPTION OF A PREFERRED EMBODIMENT

Referring now in more detail to the drawings, the invention will now be described in more detail. The detailed description that follows may be presented in terms of steps of methods or in program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or optical signals including, data, audio, and voice signals capable of being stored, transferred, combined, compared, or otherwise manipulated. A computer readable medium can be included that is designed to perform a specific task or tasks. Actual computer or executable code or computer readable code may not be contained within one file or one storage medium but may span several computers or storage mediums. The term “host” and “server” may be hardware, software, or combination of hardware and software that provides the functionality described herein.

The present invention is described with reference to flowchart illustrations of methods, apparatus (“systems”), or computer program products according to the invention. It will be understood that each block of a flowchart illustration may be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions.

The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

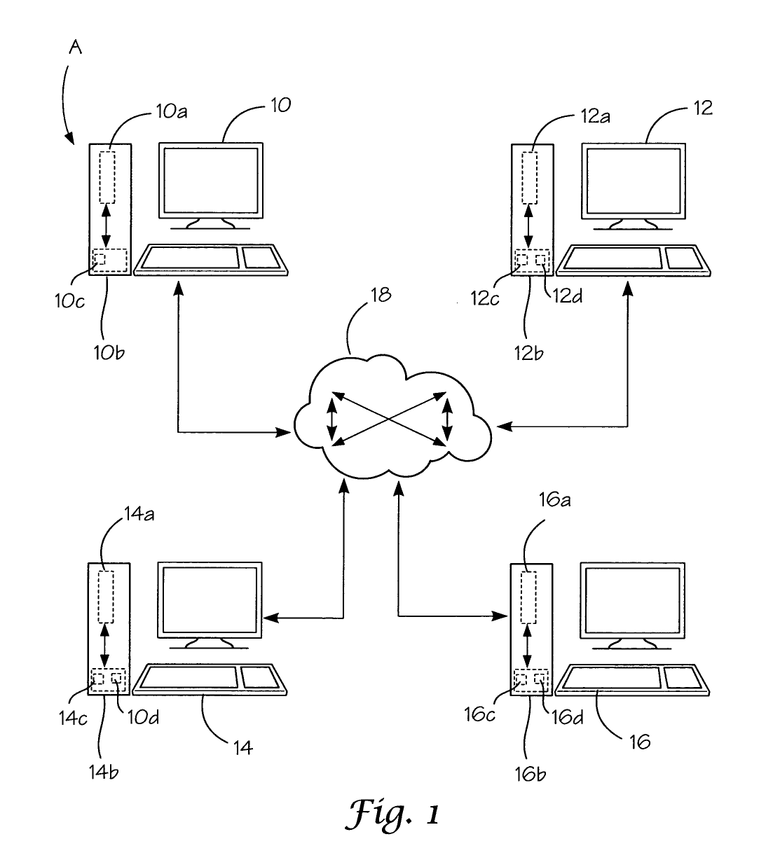

As can best be seen in FIG. 1, the components of an embodiment of the invention are illustrated. The invention is directed to a system and method for chemical process simulation. An embodiment of the system for simulating chemical processes is shown generally as A in FIG. 1. The embodiment shown here illustrates four computers having computer readable media for simulating a chemical process. Note that in alternative embodiments as few as two computers may be used to simulate chemical processes and a vast plurality of computers may be used in simulating a chemical process. Local computer 10 includes processor 10a and computer readable medium 10b. Computer readable medium 10b is in communication with local processor 10a. A set of local interface computer readable instructions 10c are shown embodied in computer readable medium 10b. Note that these instructions may be embodied in the computer readable medium as shown, or may simply be in communication with computer readable medium.

Three remote computers 12, 14, and 16 are in communication with local computer 10 and each other via network 18. Remote computer 12 will be described in more detail and it is understood that computers 14 and 16 are similar in structure and function as computer 12. Computer 12 includes processor 12a in communication with computer readable medium 12b. A set of remote interface computer readable instructions 12c are shown embodied in computer readable medium 12b. Further, simulation program 12d is shown embodied in computer readable medium 12b. As discussed above, the set of remote interface instructions and the simulation program may be embodied in the computer readable medium as shown, or alternatively may simply be in communication with the computer readable medium and may be embodied in a separate location. Simulation programs for simulating chemical processes are well known to those skilled in the art. Each remote computer may communicate with any of the other remote computers or with the local computer via network 18. Data may flow from one remote computer to the next without being transferred to local computer 10. Similarly, data may travel from local computer 10 to any or all of remote computers 12, 14, and 16.

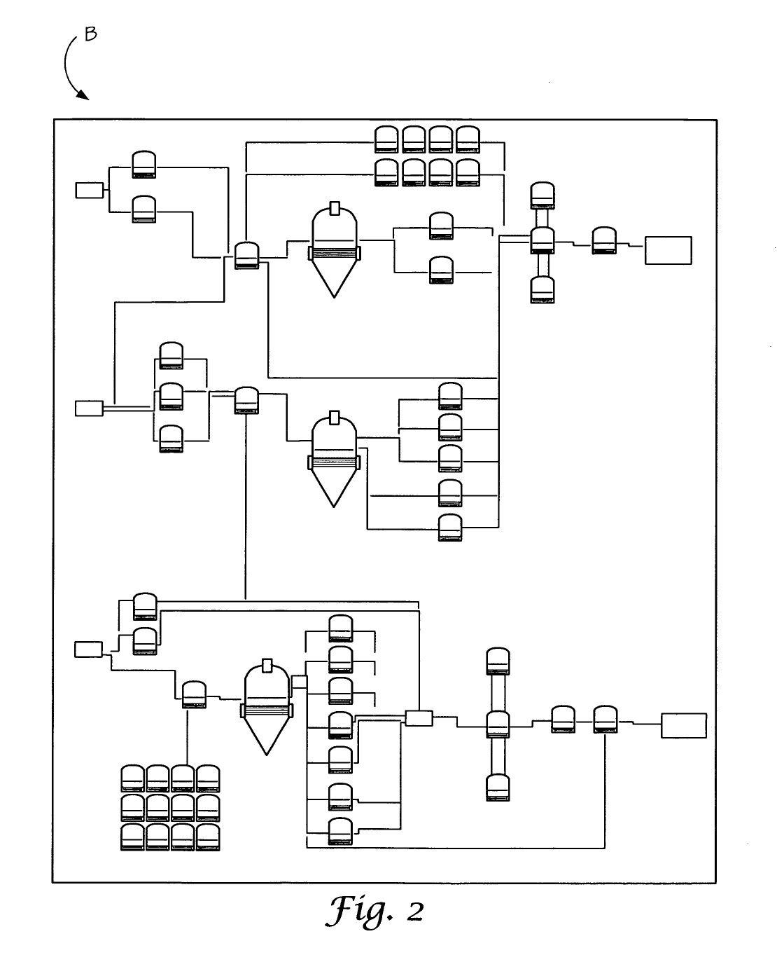

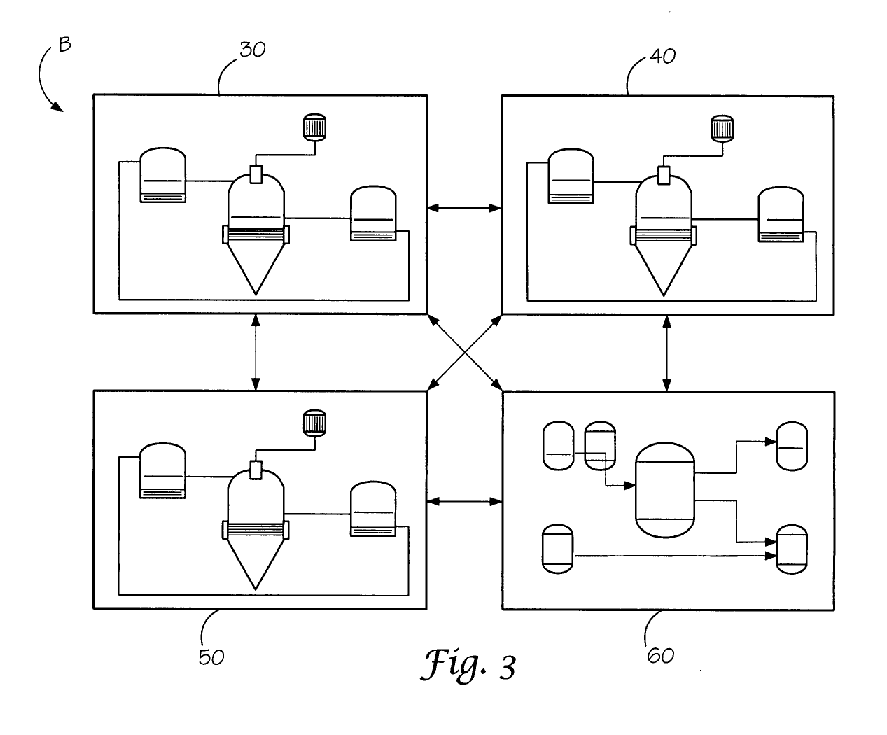

As can best be seen in FIGS. 2 and 3, a chemical process shown generally as B may be simulated using the system illustrated in FIG. 1. The system that performs the chemical process shown in FIG. 2 includes 51 tanks, 3 evaporators, a salt dissolution operation, an actinide removal process, a sludge washing process, and a waste processing facility. For this simulation to be run on a single computer, it would take days if not weeks to run. As such, the chemical process facility B is partitioned into smaller sections according to the invention. FIG. 3 illustrates the four sections 30, 40, 50, and 60 that the chemical process has been partitioned into. As can be seen in FIG. 3, the three evaporators have their processes partitioned in the sections 30, 40, and 50, and the waste processing portion has been partitioned into section 60. Each of these sections may be assigned to a computer having a simulation program for operation. The operation of each of the simulation programs is controlled so as to ensure that the process as simulated across multiple computers is accomplished in a manner that prevents the introduction of errors through the discretization process and increases the speed with which the simulation is conducted. The simulation may now be run across four computers and reduce the run time to a matter of hours rather than days.

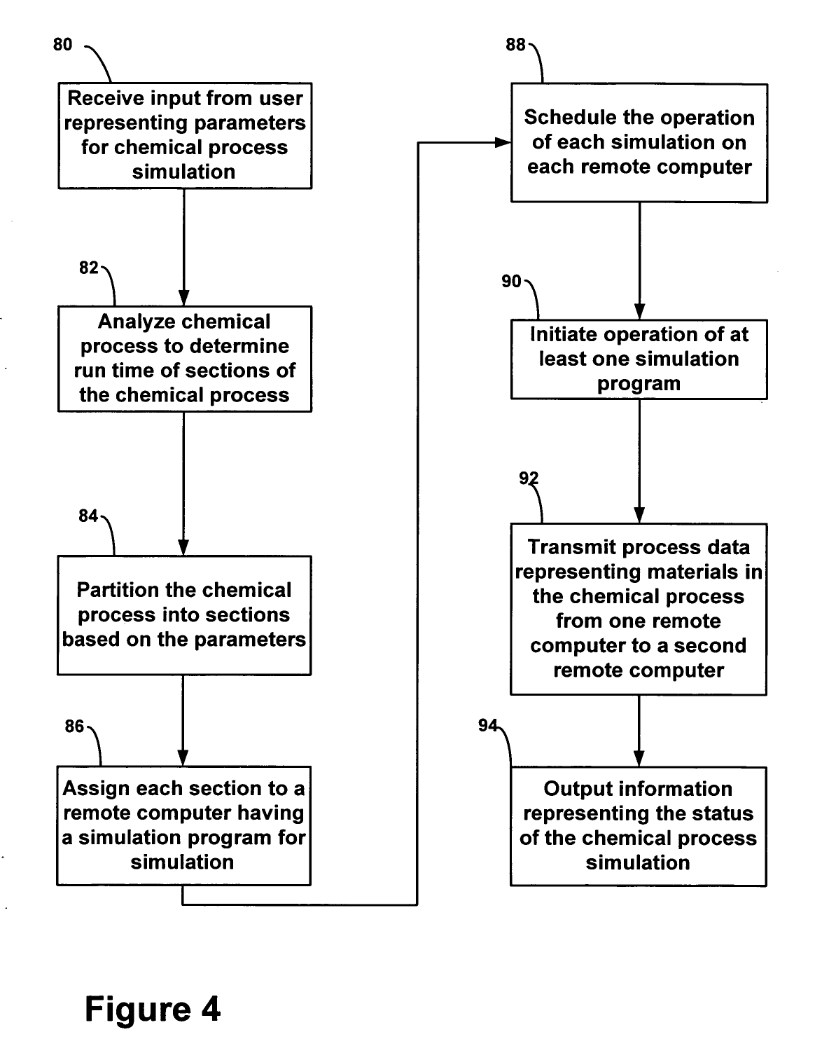

The invention achieves the goals of simulating chemical processes across multiple computers using the system in a manner as shown in FIG. 4. The system begins operation by receiving input from a user representing parameters for the chemical process simulation at step 80. The parameters entered by the user will be used in partitioning the chemical process at a later step. After receiving the input from the user at step 80, the system can be used to analyze the chemical process to determine the run times of sections of the chemical process at step 82. The system can then be partitioned into sections based on the parameters input by the user and the run times determined at step 82. The partition sections should be simulated in such a manner that they may transmit data to one another at the time in which the other section is prepared to handle that data.

After partitioning the chemical process at step 84, the system assigns each section to a remote computer having a simulation program for simulation of the chemical process section at step 86. Each computer now represents a portion of the facility used in the chemical process. As such when the computers transmit data the data represents materials being transferred from one portion of the chemical process facility to the next. As such simulation of a chemical process can be more realistically accomplished with the present invention. Once each section of the chemical process has been assigned to a remote computer, the operation of each simulation on the remote computers must be scheduled at step 88. As discussed above, the operation of each remote computer should correspond to the operation of the facility performing the chemical process so that the information being passed from one computer to the next corresponds with the materials being transferred from one portion of the chemical process facility to the next.

A block object is the fundamental unit used to transfer information uniformly between and among all modules. It is also used to store inventory and schedule information. Additionally, a vector of variables can be used to transfer information between identical blocks in different modules.

At step 90 the system initiates the operation of at least one simulation program. The simulation may begin with one section of the chemical process running independently, or alternatively, may be any combination or all of the sections of the chemical process being begun initially. The remote computers then transmit process data representing materials in the chemical process amongst one another at step 92. At step 94 the system outputs information presenting the status of the chemical process simulations. This information can include but is not limited to the run time of the chemical process, the computational details, an evaluation of the facility that performs the chemical process amongst others.

Thus, a system and method for simulating chemical processes across multiple computers thus increasing the efficiency and decreasing the run time of traditional simulations can be had according to the present invention.

While a preferred embodiment of the invention has been described using specific terms, such description is for illustrative purposes only, and it is to be understood that changes and variations may be made without departing from the spirit or scope of the following claims.

What is claimed is:

1. A system for simulating a chemical process across a plurality of computers comprising:
a local computer readable medium;
a local processor in communication with said local computer readable medium;
a remote computer readable medium in communication with said local computer readable medium;
a remote processor in communication with said remote computer readable medium;
a simulation program in communication with said local computer readable medium for simulating a chemical process;
a set of local interface computer readable instructions in communication with said local computer readable medium including:
scheduling instructions when processed by said processor for partitioning a chemical process into multiple sections, beginning and ending operation of said simulation program, and transmitting information to said remote computer readable medium and said simulation program;
input instructions when processed by said processor for receiving input from a user representing parameters for the chemical process simulation;
a set of remote interface computer readable instructions in communication with said remote computer readable medium including:
receiving instructions when processed by said processor for receiving information from said simulation program representing the status of the chemical process simulation; and
transmission instructions for when processed by said processor transmitting information to said local and remote computer readable media representing status of said chemical process simulation.

2. The system of claim 1 wherein said local interface instructions include partitioning instructions for analyzing the chemical process to be simulated based on said parameters input by the user.

3. The system of claim 1 further comprising:
a plurality of remote computer readable media in communication with said local computer readable medium; and
said set of remote interface instructions including:
data transmission instructions for transmitting process data from one remote computer readable medium to another remote computer readable medium receiving process data.

4. The system of claim 3 wherein said process data represents material that is transferred during the chemical process.

5. The system of claim 3 wherein said scheduling instructions include inventory management instructions for transmitting said process data to another remote computer readable medium only if said remote computer readable medium can receive said process data.

6. A method for simulating a chemical process across multiple computers in communication with each other comprising the steps of:
receiving input representing parameters for the chemical process to be simulated;
partitioning the chemical process into a plurality of sections based on said parameters;
assigning each section to a computer having a simulation program;
scheduling the operation of each simulation program on each computer so that the chemical process is accurately simulated;
initiating operation of at least one simulation program;
transmitting process data from one remote computer to a second remote computer; and
outputting information representing the status of the chemical process simulation.

7. The method of claim 6 wherein said step of transmitting process data represents materials transferred in the chemical process.

8. The method of claim 6 further comprising the step of analyzing the chemical process to determine run times of various sections at the chemical process.
